(19) United States
(12) Patent Application Publication
(10) Pub. No.: US 2006/0063846 A1
(43) Pub. Date: Mar. 23, 2006

(54) Silicone sponge and preparation method and usage thereof

(75) Inventor: Bo-Hwan Kim, Gimpo-si (KR)

Correspondence Address: Norris, McLaughlin & Marcus P.A., 18th Floor, 875 Third Avenue, New York, NY, 10022, US

(73) Assignee: Dong Sung Silicone CO., LTD., Gyeonggi-do (KR)

(21) Appl. No.: 11/212,425

(22) Filed: Aug. 26, 2005

(30) Foreign Application Priority Data
Aug. 27, 2004 (KR) 10-2004-0067988
Nov. 30, 2004 (KR) 10-2004-0099237
Mar. 11, 2005 (KR) 10-2005-0020379
Mar. 11, 2005 (KR) 10-2005-0020380

(51) Int. Cl. C08J 9/32

(52) U.S. Cl. 521/54

(57) ABSTRACT

Disclosed herein are a silicone sponge and preparation method and use thereof. More particularly, disclosed is a silicone sponge comprising a polyurethane sponge impregnated with a silicone solution, preparation method thereof and functional products made from the silicone sponge. The silicone sponge has excellent air permeability and elasticity, and various useful properties.

### BACKGROUND OF THE INVENTION

1. Field of the Invention

The present invention relates to a silicone sponge and preparation method and use thereof, and more particularly, to a silicone sponge comprising a polyurethane sponge impregnated with a silicone solution, as well as a preparation method thereof and functional products made from the silicone sponge.

2. Description of the Prior Art

The basic material of silicone is quartz, i.e., silica or silicon oxide (SiO₂), which is the main component of sand. Silicone is a generic term for synthetic polymers having siloxane bonds (Si—O—Si) with organic groups attached to the silicon.

Silicone sponges produced using such silicone are very flexible and have excellent resistance to heat and cold, compared to other sponges, and thus, demand for them is increasing. The silicone sponges are classified according to their foam structure, which is determined by a specific blend of raw materials, into two categories: closed cell sponges and open cell sponges. Also, they can be made into products with varying hardness and functionalities depending on their raw materials, the processing methods, and technical capability.

The silicone sponges are characterized in that they can be used at high temperatures and are light and soft, thereby having good flexibility. Also, the soft characteristic of the silicone sponges allows spaces to be easily sealed by the silicone sponges even when the spaces are not consistent. Also, this characteristic makes the installation of the sponges easy. The silicone sponges have excellent resilience and good elasticity, and thus, are widely used as super thermally resistant or insulating materials. They may be used after second vulcanization, conducted to enhance the stability of products.

Prior technologies relating to such silicone sponges will be described as follows. Korean patent publication No. 1995-0000986 discloses a method for preparing an elastic silicone foam, comprising: mixing an organic substance, polydiorganosiloxane, silicon hydride, water and a platinum catalyst so as to form bubbles at room temperature, and curing the mixture. Furthermore, Korean patent laid-open publication No. 2001-0098908 discloses a silicone rubber sponge composition prepared by making a water-in-oil emulsion containing organo-polysiloxane, organic filler, thermoplastic resin and silicone oil, and adding a curing agent to the emulsion in an amount sufficient to cure the emulsion.

In other words, the silicone sponges disclosed in the prior art were prepared by adding a chemical foaming agent either to room temperature vulcanizing (RTV) silicones, which become elastomers merely by standing at room temperature, or to high temperature vulcanizing (HTV) silicones, which become elastomers when heat is applied. Alternatively, they were expanded by hydrogen gas generated from the reaction between silicone and the curing agents. However, among the sponges prepared in these ways, the open cell sponges have problems in that the opening proportion of open foam cells is very insignificant, indicating that the sponges have little or no air permeability, and in that it is difficult to control the size of the cells. Another problem is that the foam cell film has weak strength, so that it has low resistance to repeated deformations and low tear strength.

### SUMMARY OF THE INVENTION

Accordingly, the present inventors have made efforts to solve the above-described problems occurring in the prior art, and as a result, have developed a silicone sponge adapted for use, which is prepared by impregnating a polyurethane sponge with a silicone solution. The inventive silicone sponge has excellent air permeability, and has very stable foam cells, thereby having good elasticity. Also, the silicone solution impregnated in the polyurethane sponge may contain functional substances, and thus, the inventive silicone sponge can show effects of far-infrared emission, low flammability, non-flammability, deodorization and sterilizability.

Therefore, in one aspect, the present invention provides a silicone sponge comprising a polyurethane sponge impregnated with a silicone solution, as well as functional products manufactured therefrom.

In another aspect, the present invention provides a method for preparing a silicone sponge, the method comprising the steps of: (a) mixing siloxane, an organic solvent and functional substances to prepare a silicone solution; (b) adjusting the viscosity of the silicone solution prepared in step (a); (c) impregnating a polyurethane sponge with the silicone solution from step (b); (d) pressing the polyurethane sponge from step (c) by passing it through pressure rollers; and (e) drying the polyurethane sponge from step (d) in hot air.

### BRIEF DESCRIPTION OF THE DRAWINGS

The above and other objects, features and advantages of the present invention will be more clearly understood from the following detailed description taken in conjunction with the accompanying drawings, in which:

FIG. 1a is a photograph showing a measurement result for the far-infrared energy emission of a conventional shoe sole;

FIG. 1b is a photograph showing a measurement result for the infrared energy emission of a shoe sole made from the inventive silicone sponge;

FIG. 2 is a photograph showing that the temperature of the wrist is increased by wearing a bracelet made from the inventive silicone sponge;

FIG. 3a is a photograph showing the state of erythrocytes before wearing a bracelet made from the inventive silicone sponge;

FIG. 3b is a photograph showing the state of erythrocytes after wearing a bracelet made from the inventive silicone sponge;

FIG. 4a is a photograph showing a measurement result for body temperature around the neck before wearing a necklace made from the inventive silicone sponge;

FIG. 4b is a photograph showing a measurement result for a body temperature around the neck after wearing a necklace made from the inventive silicone sponge;

FIG. 5a is a photograph showing a measurement result for the temperature of the upper body before using a mat made from the inventive silicone sponge;

FIG. 5b is a photograph showing a measurement result for the temperature of the upper body after using a mat made from the inventive silicone sponge;

FIG. 6a is a photograph showing a measurement result for the temperature of the upper body before wearing a brassiere made from the inventive silicone sponge;

FIG. 6b is a photograph showing a measurement result for the temperature of the upper body after wearing a brassiere made from the inventive silicone sponge;

FIG. 7a is a photograph showing the state of erythrocytes before wearing a brassiere made from the inventive silicone sponge;

FIG. 7b is a photograph showing the state of erythrocytes after wearing for 30 minutes a brassiere made from the inventive silicone sponge; and

FIG. 7c is a photograph showing the state of erythrocytes after wearing for 60 minutes a brassiere made from the inventive silicone sponge.

### DETAILED DESCRIPTION OF THE INVENTION

The present invention provides a silicone sponge, which is characterized by being produced by impregnating a polyurethane sponge with a silicone solution, as well as a preparation method thereof.

As used herein, the term “impregnation” means that the silicone solution is caused to infiltrate into the surface and inside of a polyurethane sponge so as to change the characteristics of the polyurethane sponge.

As the polyurethane sponge, polyether foam or polyester foam may be used in the present invention.

Polyurethane forming the polyurethane sponge is a thermosetting synthetic resin produced by the reaction of isocyanate with polyol and is widely used to manufacture various materials because its physical properties are easily adjusted according to the synthetic ratio of isocynate to polyol, and it is convenient to handle. This polyurethane may be used in the form of a sponge containing a foaming agent therein. In addition, it is used in light shoe soles, automobile interior materials, and the like.

As the polyurethane in the present invention, a family of sponge-like polyurethane foams having many pores formed therein may be used. Generally such sponge-like polyurethane foams are divided into polyether foam and polyester foam. It is preferable in the present invention to use polyester foam, because polyester foam may be easily made into an open-cell foam structure.

The method of manufacturing the polyurethane sponge having the open-cell foam structure may comprise removing a surface film formed on a prepared polyurethane sponge by means of machines or the like.

Moreover, the silicone solution which is impregnated into the polyurethane sponge according to the present invention may be used a solution containing siloxane (Si—O—Si). Examples of siloxane, which can be used in the present invention, include dimethylpolysiloxane, methylhydrogenpolysiloxane, and methylphenylpolysiloxane, dimethylpolysiloxane being preferred.

The silicone solution used in the present invention may be prepared by mixing siloxane with an organic solvent. Examples of an organic solvent that can be used in the present invention include hydrocarbons, such as xylene, benzene and toluene, lower alcohols, such as ethanol, methanol and isopropanol, ketones, such as acetone and methyl ethyl ketone, lower fatty esters, such as methyl acetate, ethyl acetate, and butyl acetate, and ethers, such as methyl ether, ethyl ether, tetrahydrofuran, and dioxane. Preferred examples of the organic solvent include hydrocarbons, such as xylene, benzene and toluene.

In addition, according to the present invention, the silicone sponge prepared by impregnating the silicone solution into the polyurethane sponge can be provided with functionalities by the addition of functional substances. Examples of functional substances, which can be used in the present invention, include, but are not limited to, an antibacterial agent, a flame retardant agent, a photocatalyst and a natural mineral. These functional substances may preferably be used alone or in mixtures of two or more.

The antibacterial agent, among the functional substances used in the present invention, is used to inhibit the proliferation of bacteria or viruses, thus preventing the production of offensive odors and contaminants.

Examples of antibacterial agents that can be used in the present invention include metals, such as silver, copper and zinc, natural antibacterial agents, such as mustard and cypress, and organic substances, such as thiobendazole, bisphenol and quaternary ammonium salts. The antibacterial agent may be added in an amount of 0.2-20% by weight based on the total weight of the silicone solution.

The flame retardant agent that can be used in the present invention is added to physically and chemically improve the flame retardance of organic substances consisting of carbon, hydrogen and oxygen, such as synthetic resins and plastics, thus reducing the inflammability of these organic substances.

Examples of flame retardant agent that can be used in the present invention include halogen-, phosphorus-, inorganic substance-, melamine- and chlorine-based flame retardant agents, and the flame retardant agent may be added in an amount of 0.2-20% by weight based on the total weight of the silicone solution.

The photocatalyst, which can be used in the present invention, acts to catalyze oxidation and reduction due to light as an energy source, thus performing various functions, such as the removal of various bacteria and offensive odors, the decomposition of organic substances, such as environmental hormones, the removal of contaminants, and the shielding of UV light.

The photocatalyst used in the present invention is most preferably titanium dioxide, and may be added in an amount of 0.2-20% by weight based on the total weight of the silicone solution.

The natural mineral, which can be used as one of the functional substances in the present invention, emits anions, weak current and far-infrared rays, and thus, is added to achieve health promotion effects, such as cellular activation, increased immunity, blood purification, the promotion of blood circulation, the inhibition of sympathetic nerve stimulation, fatigue relief, muscle pain relief and nerve pain relief.

Examples of natural minerals that can be used in the present invention include tourmaline, Jeju ore, nanotitanium, rare earth minerals, diatomite, sericite and bio-stone. The natural mineral may be added in an amount of 0.2-20% by weight based on the total weight of the silicone solution.

Meanwhile, a mixture obtained by selecting, mixing and sintering two or more of the above-described functional components may also be used. One example of this mixture is “silver-natural mineral powder”.

The silver-natural mineral powder may be prepared using a preparation method comprising the steps of (a) preparing a silver solution, (b) adding a natural mineral to the silver solution; (c) extruding the silver solution containing the natural mineral; (d) sintering the extruded material; and (e) powdering the sintered material.

In step (a) of the preparation method, the silver solution may be prepared by the electrolysis of silver metal in distilled water. In order for the desired amount of silver to be effectively dissociated, the electrolysis is performed at a voltage of 100-200 V, preferably 125-175 V, and more preferably 140-160 V. Furthermore, the electrolysis is carried out until the silver content in the silver solution reaches 10-200 ppm, preferably 50-150 ppm and more preferably 80-120 ppm.

In step (b) of the preparation method, the above-described natural mineral is added to the silver solution prepared in step (a). Specifically, the natural mineral may be added in an amount of 10-99% by weight, preferably 15-70% by weight, and more preferably 20-50% by weight, based on the total weight of the mixture. The silver metal may be added in an amount of 1-90% by weight, preferably 5-50% by weight and more preferably 10-30% by weight, based on the total weight of the mixture.

In step (c) of the preparation method, the natural mineral-containing silver solution from step (b) is extruded. The extrusion may be performed using a conventional method, such as screw-type extrusion or pressing.

In step (d) of the preparation method, the formed material resulting from the extrusion of the silver solution containing the natural minerals is sintered to induce the reaction between the natural minerals and the silver metal. The sintering temperature should be higher than the melting points of the natural mineral and the silver but lower than their oxidation temperatures. Specifically, the sintering should be carried out at a temperature of about 300-600° C., preferably 350-550° C., and more preferably 400-500° C.

In step (e) of the preparation method, the sintered material from step (d) is powdered. The powdering is carried out until the diameter of powder reaches 10-50 μm, and preferably 20-40 μm.

In the present invention, the silver-natural mineral powder may be added in an amount of 0.5-20% by weight, preferably 1-15% by weight and more preferably 5-10% by weight, based on the total weight of the silicone solution.

Another example of a mixture obtained by selecting and mixing two or more of the above-described functional components is “silver-iodine-plated active carbon”.

The silver-iodine-plated active carbon may be prepared through the steps of: (a) electroplating active carbon in a plating bath consisting of an aqueous silver salt solution; (b) washing and drying the silver-plated active carbon; and (c) electroplating the washed and dried active carbon in a plating bath consisting of an aqueous iodine salt solution.

Examples of silver salts which can be used in the present invention include silver nitrate (AgNO₃), silver acetate (CH₃CO₂Ag) and silver cyanide (AgCN), and examples of iodine salts include potassium iodate (KIO₃) and sodium iodate (NaIO₃).

The concentration of the silver compound in the electroplating solution is preferably 1-10% by weight. If the concentration of the silver compound is less than 1% by weight, the concentration of an electrolyte dissociated by electrolysis will be low, so that the content of the silver component plated on the surface of the active carbon will also be low. If the concentration of the silver compound is more than 10% by weight, the concentration of a dissociated electrolyte will be high, so that precipitation of the silver in the electrolytic solution will occur, and the surface structure of the active carbon will change, thereby reducing the adsorption performance of the active carbon.

The concentration of the iodine compound in the electroplating solution is preferably 5-30% by weight. If the concentration of the iodine compound is less than 5% by weight, the concentration of an electrolyte dissociated by electrolysis will be low, therefore the content of the iodine component adhering to the surface of the active carbon will also be low. If the concentration of the iodine compound is more than 30% by weight, the concentration of a dissociated electrolyte will be high, so that the surface structure of the active carbon will change, thereby reducing the adsorption performance of the active carbon.

In the present invention, the electrolysis is preferably performed at a voltage of 1-5 V. At less than 1 V, the concentration of an electrolyte dissociated by electrolysis will be low, therefore the amount of silver and iodine plated on the surface of the active carbon will be low. At more than 5 V, the concentration of a dissociated electrolyte will be high, so that precipitation of the silver and iodine in an electrolytic solution will occur, and the surface structure of the active carbon will change, thereby leading to a reduction in adsorption performance.

Moreover, in the present invention, the intensity of electric current is preferably 0.1-5.0 A. At less than 0.1 A, the concentration of an electrolyte dissociated by electrolysis will be low, therefore the amount of silver and iodine plated on the surface of the active carbon will be low. At more than 5.0 A, the concentration of a dissociated electrolyte will be high, so that precipitation of the silver and iodine in the electrolytic solution will occur, and the surface structure of the active carbon will change, thereby leading to a reduction in adsorption performance.

In the present invention, electrolysis is preferably performed for 10-120 seconds. For less than 10 seconds, the concentration of an electrolyte dissociated by electrolysis will be low, therefore the amount of silver and iodine components plated on the surface of the active carbon will be low. For more than 120 seconds, the concentration of a dissociated electrolyte will be high, so that precipitation of the silver and iodine in the electrolytic solution will occur, and the surface structure of the active carbon will change, thereby reducing the adsorption performance of the active carbon.

In the present invention, the silver-iodine-plated active carbon may be added in an amount of 0.5-20% by weight, preferably 1-15% by weight, and more preferably 5-10% by weight, based on the total weight of the silicone solution.

In another aspect, the present invention provides a method for preparing a silicone sponge, the method comprising the steps of: (a) mixing siloxane, organic solvent and functional substances to prepare a silicone solution; (b) adjusting the viscosity of the silicone solution prepared in step (a); (c) impregnating a polyurethane sponge with the silicone solution from step (b); (d) pressing the polyurethane sponge from step (c) by passing it through pressure rollers; and (e) drying the polyurethane sponge from step (d) in hot air.

Hereinafter, the method for preparing the inventive silicone sponge will be described in detail.

In step (a), the silicone solution may be prepared by mixing 60-80% by weight, based on the total weight of the silicone solution, of siloxane, 20-40% by weight of organic solvent, and 0.2-20% by weight of functional substances, and stirring the mixture for 1-60 minutes, and preferably 20-40 minutes, so as to uniformly disperse the siloxane in the organic solvent.

The functional substances which can be used in step (a) include an antibacterial agent, a flame retardant agent, a photocatalyst and a natural mineral, as described above, and may be used alone or in a mixture of two or more substances.

In step (b), organic solvent may be additionally added to the silicone solution prepared in step (a) so as to adjust the viscosity of the silicone solution; the viscosity of the silicone solution may be adjusted to 2,000-800,000 cp.

In step (c), the impregnation of the silicone solution into the polyurethane sponge is performed for 1-30 minutes, and preferably 2-10 minutes, such that the silicone solution sufficiently infiltrates into the polyurethane sponge.

In step (d), in order to adjust the amount of the silicone solution impregnated into the polyurethane sponge, the polyurethane sponge from step (c) is passed 1-10 times through the pressure rollers.

In step (e), in order to dry the polyurethane sponge from step (d), the polyurethane sponge can be dried in hot air by being passed through, for example, a conveyer dryer. In this regard, the hot air drying may be carried out for 1-30 minutes, and preferably 5-15 minutes, at a temperature of 10-100° C., and preferably 30-70° C., but such conditions may be adjusted depending on the amount of the impregnated silicone solution.

Also in step (e), in order to allow the polyurethane sponge to be easily passed through the conveyer dryer in the hot air drying process, a press, such as a hydraulic press, may be used to press the polyurethane sponge.

Meanwhile, since the inventive silicone sponge prepared by the preparation method as described above can be made into various functional products, any person skilled in the art will understand that the inventive silicone sponge can be cut to correspond to the shape of the desired functional products.

The inventive silicone sponge can be made into various functional products. Functional products which can be made from the inventive silicone sponge include sheets or cushions for vessels, automobiles and railroad cars, interior building materials, shoe soles, shoe insoles, cushions, mattresses, underwear (e.g., brassieres and panties), accessories, and sport clothes.

Also, the silicone sponge according to the present invention can be made into protective bands which are used to protect the human body from external influences by covering skin sites where the joints, bones and the like of the body are located, and to remove offensive odors and bacteria caused by exudates, such as sweat, on sites wearing the bands. Any protective band will be within the scope of the present invention if it can achieve such purposes, but preferred examples of the protective bands made from the inventive silicone sponge include wrist bands, knee bands, ankle bands, elbow bands, waist bands, and shoulder bands.

The silicone sponge according to the present invention can be made into filters which are used to remove organic substances, such as volatile organic compounds and environmental hormones, offensive odors, mold or bacteria Any filter will be within the scope of the present invention if it achieves this purpose, but preferred examples of the silicone sponge filters according to the present invention include filters for use in air conditioners, fan heaters, air cleaners, automobile air conditioners, building air conditioners, humidifiers, and air-conditioning equipment.

Hereinafter, preferred examples will be presented for a better understanding of the present invention. It is to be understood, however, that these examples are provided for illustrative purpose only, and are not to be construed to limit the scope of the present invention.

### EXAMPLES

### Example 1

### Preparation of Silicone Sponge

70% by weight of dimethylpolysiloxane, 25% by weight of xylene and 5% by weight of tourmaline were mixed with each other to prepare a silicone solution.

Meanwhile, 10 liters of the prepared silicone solution was impregnated into a polyurethane sponge (Shinwha Urethane Co., Ltd., Korea) for 5 minutes.

Also, the polyurethane sponge impregnated with the silicone solution was passed two times through pressure rollers (Halla Climate Control Corp., Korea), and then dried in hot air by passing it through a conveyer dryer (Jin Vibro Tech Machinery Co., Korea) for 10 minutes, thus preparing a silicone sponge.

### Example 2

### Measurement of Far-Infrared Emission of a Shoe Sole made from Silicone Sponge

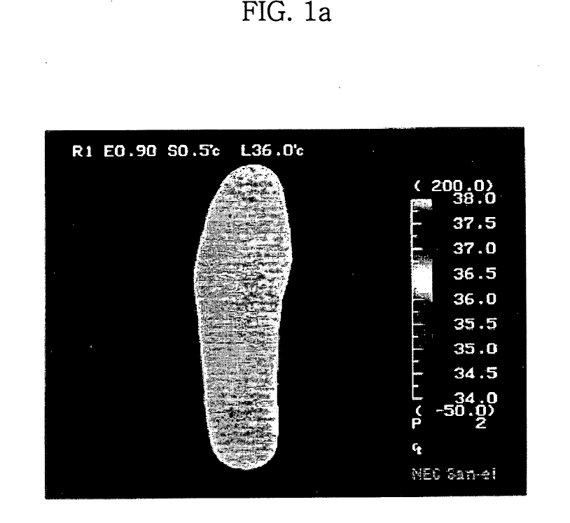

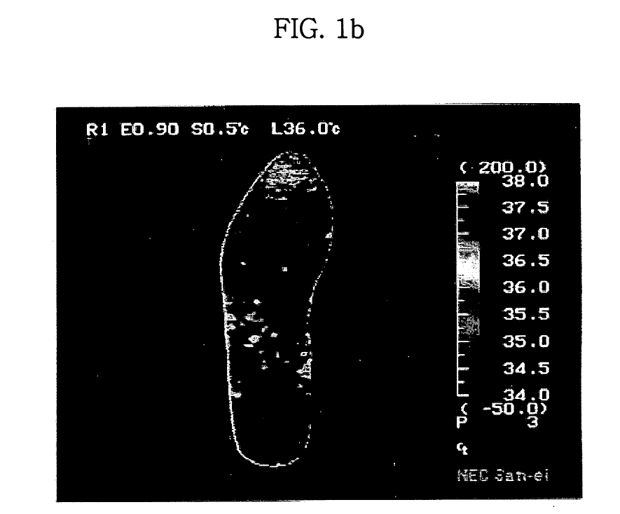

The silicone sponge prepared in Example 1 was used to manufacture a shoe sole, and infrared energy emitted from the shoe sole was measured with an infrared thermal imaging device at a temperature of 29° C. and a humidity of 41%. Meanwhile, a conventional shoe sole was used as a control group. The measurement results are shown in FIGS. 1a and 1b, respectively.

As shown in FIGS. 1a and, 1b, the shoe sole made from the inventive silicone sponge emitted a large amount of infrared energy (see FIG. 1a), but the emission of infrared rays from the control group was insignificant (see FIG. 1b).

### Example 3

### Measurement of Far-Infrared Emission of a Bracelet made from Silicone Sponge

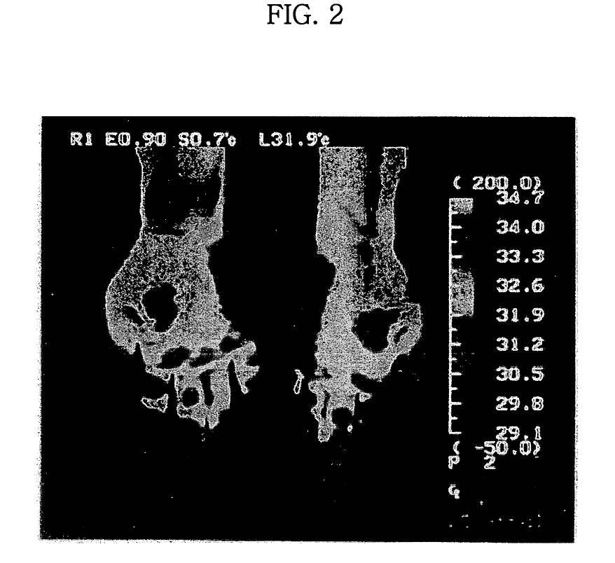

The silicone sponge prepared in Example 1 was used to manufacture a bracelet, and after wearing the bracelet for 10 minutes, changes in body temperature around the wrist were photographed with a digital thermal imaging system at a temperature of 25° C. and a relative humidity of 40%. Meanwhile, a wrist wearing no bracelet made from the inventive silicone sponge was used as a control. The measurement results are shown in FIG. 2.

As shown in FIG. 2, the wrist wearing the bracelet made from the inventive silicone sponge showed increased blood circulation, leading to an increase in body temperature (see the left side of FIG. 2), but the control showed an insignificant increase in body temperature (see the right side of FIG. 2).

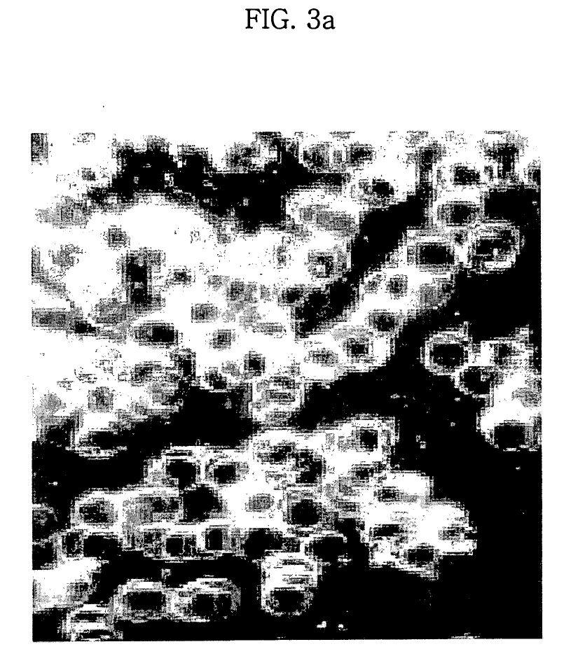

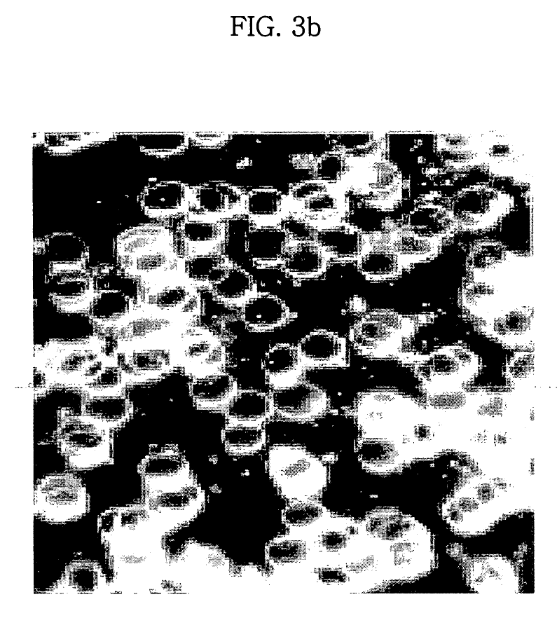

In addition, before and 30 minutes after wearing the bracelet, blood samples were collected, and the shape, color and distribution of erythrocytes in the blood were measured with an erythrocyte measurement system. The measurement results are shown in FIGS. 3a and 3b.

As shown in FIGS. 3a and 3b, the acidity of blood was restored to its original state by wearing the bracelet made from the inventive silicone sponge so that the shape, color and distribution of erythrocytes were restored to healthy states.

### Example 4

### Measurement of Far-Infrared Emission of a Necklace made from Silicone Sponge

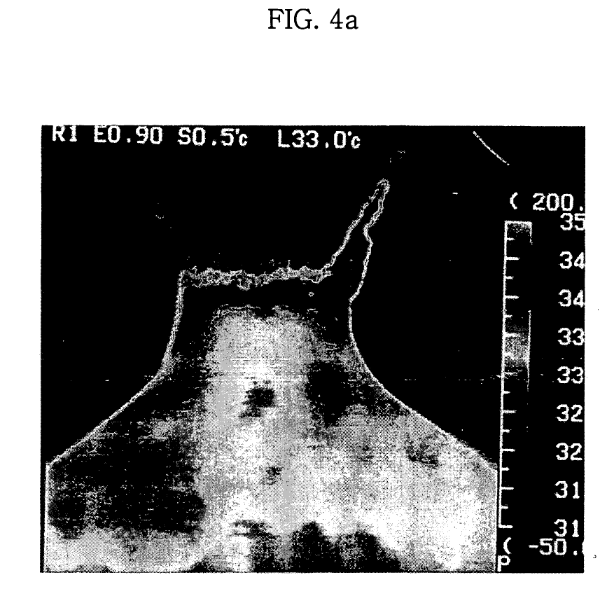

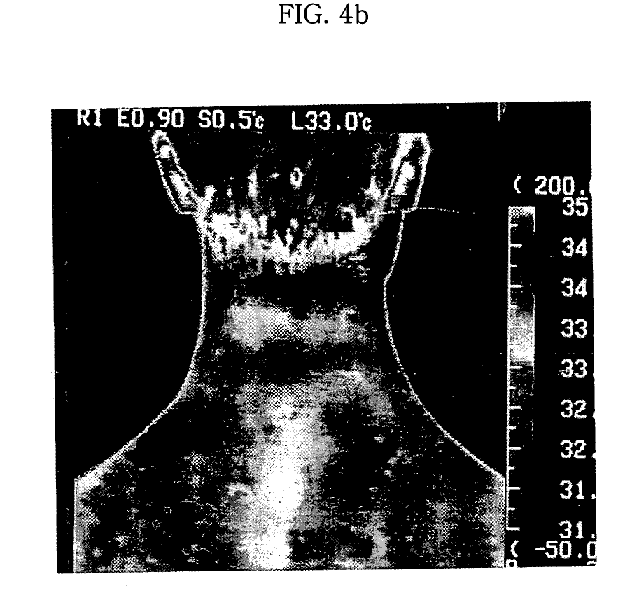

The silicone sponge prepared in Example 1 was used to manufacture a necklace, and before and after wearing the necklace for 10 minutes, changes in body temperature around the neck were photographed with a digital thermal imaging system at a temperature of 25° C. and relative humidity of 40%. The measurement results are shown in FIGS. 4a and 4b.

As shown in FIGS. 4a and 4b, the neck wearing the necklace made from the inventive silicone sponge showed increased blood circulation, leading to an increase in body temperature (see FIG. 4b), but the control wearing no necklace made from the inventive silicone sponge showed an insignificant increase in body temperature (FIG. 4a).

### Example 5

### Measurement of Far-Infrared Emission of a Mat made from Silicone Sponge

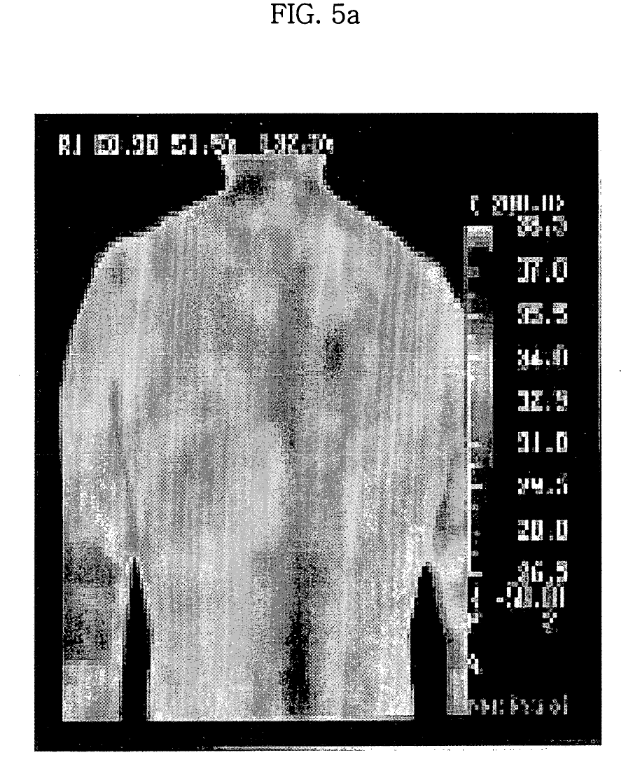

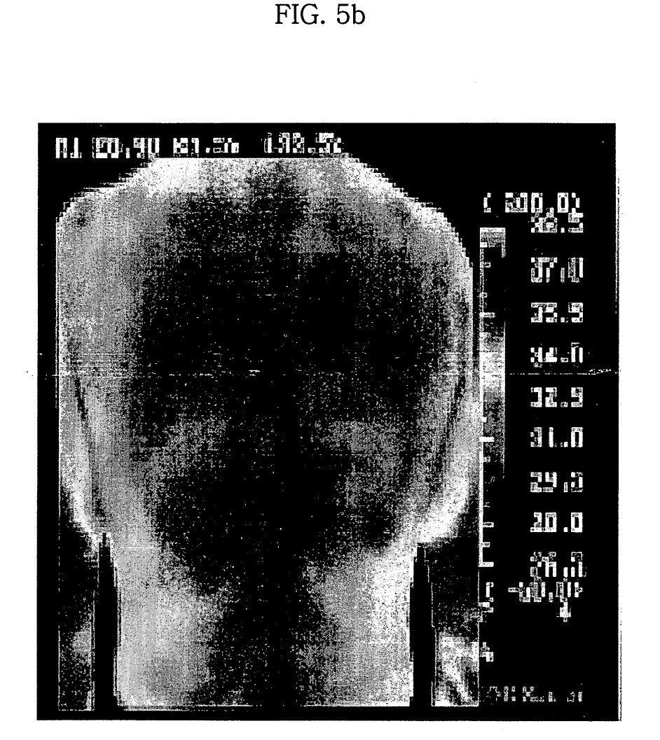

The silicone sponge prepared in Example 1 was used to manufacture a mat, and after lying on the mat for 10 minutes, a change in the temperature of the upper body was measured with a digital thermal imaging system at a temperature of 25° C. and relative humidity of 40%. Meanwhile, a conventional mat was used as a control. The measurement results are shown in FIGS. 5a and 5b.

As shown in FIGS. 5a and 5b, the use of the mat made from the inventive silicone sponge increased blood circulation in the upper body, leading to an increase in body temperature (see FIG. 5b), but the control showed an insignificant increase in body temperature (see FIG. 5a).

### Example 6

### Measurement of Far-Infrared Emission of a Brassiere made from Silicone Sponge

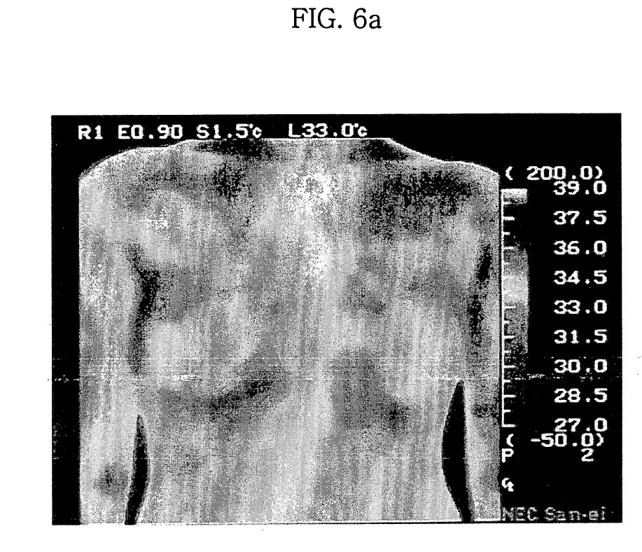

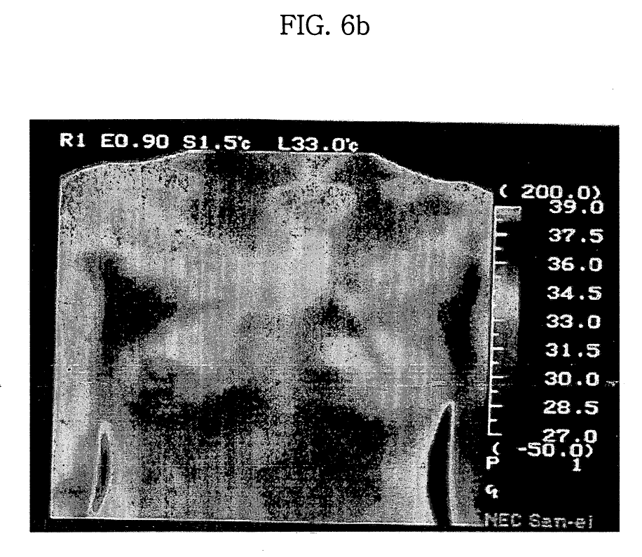

The silicone sponge prepared in Example 1 was used to manufacture a brassiere, and before and after wearing the brassiere for 15 minutes, changes in the temperature of the upper body were photographed with a digital thermal imaging system at a temperature of 25° C. and a relative humidity of 40%. The measurement results are shown in FIGS. 6a and 6b.

As shown in FIGS. 6a and 6b, the brassiere made from the inventive silicone sponge clearly showed the emission of a large amount of infrared energy.

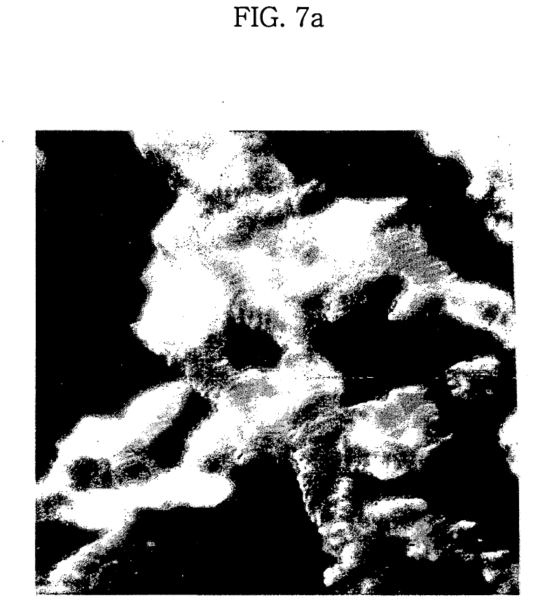

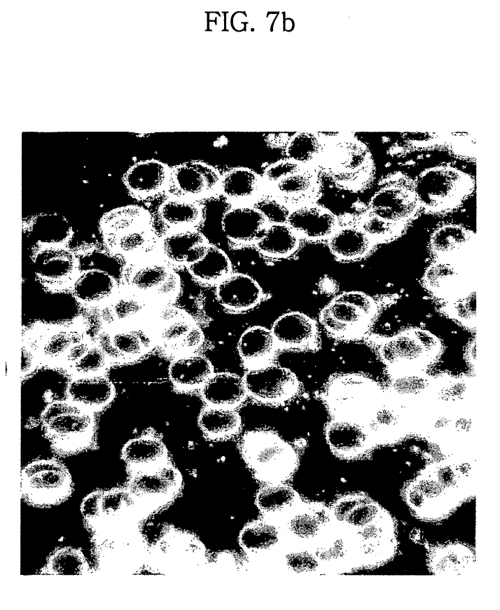

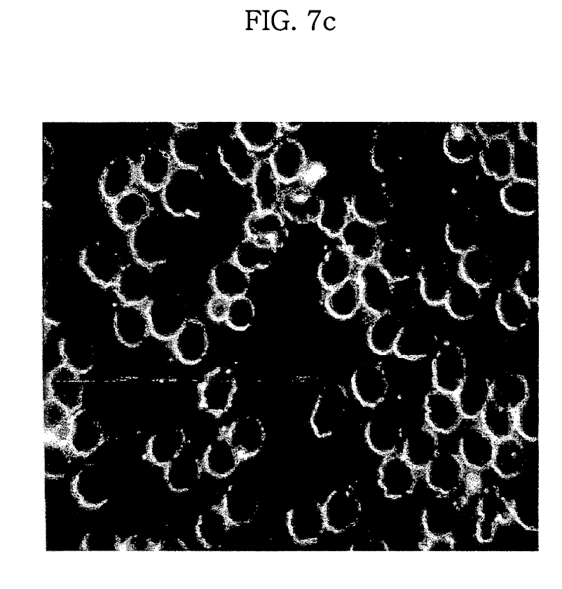

In addition, before wearing the brassiere and after wearing the brassiere for 30 minutes and 60 minutes, blood samples were collected, and the shape, color and distribution of erythrocytes in blood were measured with an erythrocyte measurement system. The measurement results are shown in FIGS. 7a, 7b and 7c.

As shown in FIGS. 7a, 7b and 7c, the acidity of blood was restored to its original state by wearing the brassiere made from the inventive silicone sponge, so that the shape, color and distribution of erythrocytes in blood were restored to healthy states.

As can be seen from the foregoing, the inventive silicone sponge has excellent air permeability and has stable foam cells, leading to good elasticity. Also, since the silicone solution impregnated in the polyurethane sponge contains functional substances, the inventive silicone sponge can show the effects of far-infrared emission, low flammability, non-flammability, deodorization and sterilizability. In addition, the use of functional products made from the inventive silicone sponge can show health promotion effects, such as blood purification, increased blood circulation, fatigue relief, and muscle pain relief.

1. A silicone sponge comprising a polyurethane sponge impregnated with a silicone solution containing one or two or more selected from the group consisting of an antibacterial agent, a flame retardant agent, a photocatalyst, and a natural mineral.

2. The silicone sponge of claim 1, wherein the antibacterial agent is contained in an amount of 0.2-20% by weight based on the total weight of the silicone solution, the flame retardant agent is contained in an amount of 0.2-20% by weight based on total weight of the silicone solution, the photocatalyst is contained in an amount of 0.2-20% by weight based on the total weight of the silicone solution, and the natural mineral is contained in an amount of 0.2-20% by weight based on the total weight of the silicone solution.

3. A method for preparing a silicone sponge, the method comprising the steps of:
(a) mixing siloxane, an organic solvent and functional substances to prepare a silicone solution;
(b) adjusting the viscosity of the silicone solution prepared in step (a);
(c) impregnating a polyurethane sponge with the silicone solution from step (b);
(d) pressing the polyurethane sponge from step (c) by passing the polyurethane sponge through pressure rollers; and
(e) drying the polyurethane sponge from step (d) in hot air.

4. The method of claim 3, wherein, in step (a), 60-80% by weight of the siloxane, 20-40% by weight of the organic solvent and 0.2-20% by weight of the functional substances, based on the total weight of the silicone solution, are mixed with each other and the mixture is stirred for 1-60 minutes.

5. The method of claim 3, wherein, in step (b), organic solvent is additionally added to the silicone solution to adjust the viscosity of the silicone solution to 2,000-800,000 cp.

6. The method of claim 3, wherein, in step (c), the polyurethane sponge is impregnated with the silicone solution for 1-30 minutes.

7. The method of claim 3, wherein, in step (d), the polyurethane sponge is passes 1-10 times through the pressure rollers.

8. The method of claim 3, wherein, in step (e), the pressed polyurethane sponge is dried in hot air.

9. A functional product from a silicone sponge as set for in claim 1.

10. The functional product of claim 9, which is any one selected from the group consisting of sheets or cushions for use in vessels, automobiles and railroad cars, interior building materials, shoe soles, shoe insoles, cushions, mattresses, underwear, accessories, sport clothes, protective bands, and filters.
